(19) United States
(12) Patent Application Publication
(10) Pub. No.: US 2018/0202234 A1
(43) Pub. Date: Jul. 19, 2018

(54) ATTACHMENT OF POLYCRYSTALLINE DIAMOND TABLES TO A SUBSTRATE TO FORM A PCD CUTTER USING REACTIVE/EXOTHERMIC PROCESS

(71) Applicant: Halliburton Energy Services, Inc., Houston, TX (US)

(72) Inventors: Gagan Saini, The Woodlands, TX (US); Grant O. Cook, III, Spring, TX (US); William Brian Atkins, Houston, TX (US)

(21) Appl. No.: 15/744,664

(22) PCT Filed: Aug. 17, 2015
(86) PCT No.: PCT/US2015/045542

§ 371 Date: Jan. 12, 2018

(51) Int. Cl. E21B 10/573; B23K 1/00; B23K 1/19; B23K 20/16; B23K 20/233

(52) U.S. Cl. CPC E21B 10/5735; B23K 1/0006; B23K 1/0008; B23K 2201/20; B23K 20/165; B23K 20/233; B23K 1/19

(57) ABSTRACT

A PCD cutter formed by a reactive/exothermic bond formed between the diamond table and the substrate. The bond is formed by applying a small pulse of localized energy to a bonding agent containing exothermic reactive materials which is disposed at the interface of the diamond table and the substrate. The bonding agent may be formed by depositing a plurality of alternating layers of exothermic foils at the interface between the polycrystalline diamond table and the substrate. Additional layers may also be deposited between the polycrystalline diamond table and the plurality of layers of exothermic foils and between the foils and the substrate. One or more refractory layers may also be disposed between the layers of exothermic material and a masking or non-wetting material may be applied to one or more sides of the substrate and diamond table.

### TECHNICAL FIELD

The present disclosure relates generally to drilling tools, such as earth-boring drill bits, and more particularly to improved techniques for bonding thermally stable polycrystalline (TSP) diamond tables to substrates in the manufacture of cutters.

### BACKGROUND

Various types of drilling tools including, but not limited to, rotary drill bits, reamers, core bits, and under reamers are used to form wellbores in downhole formations. Over the past several decades, there have been advances in the materials used to form drill bits. The cutting elements or cutters as they are sometimes called were once formed of natural diamond substances. Because of cost and other reasons, the industry sought alternative materials. In the mid-to-late 1970s, advances in synthetic diamond materials enabled the industry to replace natural diamond cutters with synthetic diamond cutters. The most common synthetic diamond that is used is a polycrystalline diamond material. These materials are formed into discs also known as compacts. Drill bits which use such synthetic diamond cutters are commonly referred to as polycrystalline diamond compact (PDC) bits.

The cutters are typically formed by attaching a polycrystalline diamond (PCD) disc or table to a substrate typically formed of a cemented carbide material. The PCD tables themselves are sometimes leached to remove any sintering aids that may exist in the interstitial spaces so as to create a thermally stable polycrystalline (TSP) diamond prior to attachment to the substrate. The substrates on which the PCD tables are mounted are typically formed of a tungsten carbide material. The cutters mount onto the blades formed on the drill bit body.

There are a number of different methods of attaching the PCD tables to the substrate. One such method involves placing the PCD table with the substrate into a press and subjecting these components to a HTHP (high temperature/high pressure) cycle. Often the PCD table is leached a second time following attachment to the substrate. The leaching process can be costly because it often takes many days to complete thereby lengthening the time it takes to manufacture the cutters. In another method, the PCD table is vacuum brazed to the substrate. This alternate method, however, subjects the resultant disc to residual stresses.

### BRIEF DESCRIPTION OF THE DRAWINGS

For a more complete understanding of the present invention and its features and advantages, reference is now made to the following description, taken in conjunction with the accompanying drawings, in which:

FIG. 1 is a schematic diagram illustrating the bonding of a PCD table to a substrate via an exothermic reaction which is created using an energy source and plurality of layers of an exothermic material and optionally additional layers;

FIG. 2 is a phase diagram for an exothermic bond-forming bilayer of Al—Ni; and

FIG. 3 is a flow chart showing an exemplary method in accordance with the present disclosure.

### DETAILED DESCRIPTION

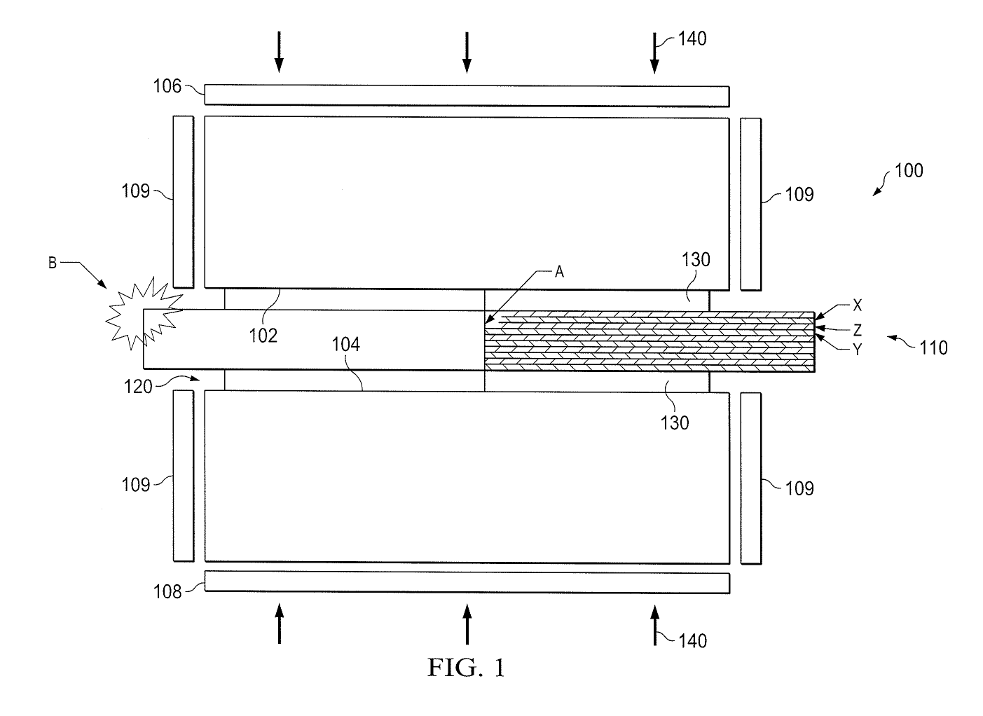

The present disclosure is directed, in part, to improving the thermo-mechanical integrity of drill bit cutters as well as their wear/abrasion resistance and also to minimize the failure of the bond between the PCD tables and substrate The present disclosure includes, more particularly, the use of a localized reactive/exothermic process to form this bond. The present disclosure and its advantages may be understood by referring to FIGS. 1 through 3.

Turning to FIG. 1, an improved PCD cutter 100 in accordance with the present disclosure is illustrated. The PCD cutter 100 is made by attaching PCD table 102, which may be a thermally stable polycrystalline (TSP) diamond, to a substrate 104. The substrate 104 may be made of a cobalt-cemented tungsten carbide material. A bonding agent 110 is disposed at an interface 120 of the diamond table 102 and the substrate 104.

In one exemplary embodiment, the bonding agent (multilayer foil) 110 may be an exothermic bond layer which more specifically may consist of multiple alternating layers of different thin metallic films. A self-propagating exothermic reaction, as indicated by the arrow A, is initiated at the interface 120 within the multilayer system that contributes heat locally to bond the PCD table 102 to the cemented-WC substrate 104. Arrow A indicates the boundary between the bond which has already formed between the PCD table 102 and the cemented-WC substrate 104 (located to the left of the vertical boundary line at A) and the multiple layers of thin metallic films about to undergo the exothermic reaction (located to the right of the boundary line at A). The reaction may be initiated at one end of the interface 120, as indicated by Arrow B. Based on the limited thermal energy that the substrate material is exposed to, this process may prevent, or at least minimize, graphitization of the diamond so that little to no thermal damage occurs while also managing residual stresses at the interface due to coefficient of thermal expansion mismatch between TSP diamond, cemented-carbides and metallic layers. To further control the thermal energy input, thermal sinks 106 and 108 may be placed adjacent to the PCD table 102 and/or the substrate 104 material to quickly draw heat out from the bonded assembly.

The multilayer foil 110 (which, in one embodiment, is on the order of nanometers in thickness) provides instantaneous heat in a controlled and precise manner for the joining or brazing operation. The reactive multilayer foil 110 may be fabricated by vapor-depositing thousands of alternating nanoscale layers of two distinct materials (indicated by arrows X and Y in FIG. 1). This process may be made economical (from a cost or lead-time standpoint) by batch processing of cutters during deposition or depositing onto a suitable non-reactive surface for transfer of thin composite foils onto the cutters or purchasing sheets or preforms of an exothermic material, such as those sold under the trademark Nanofoil®.

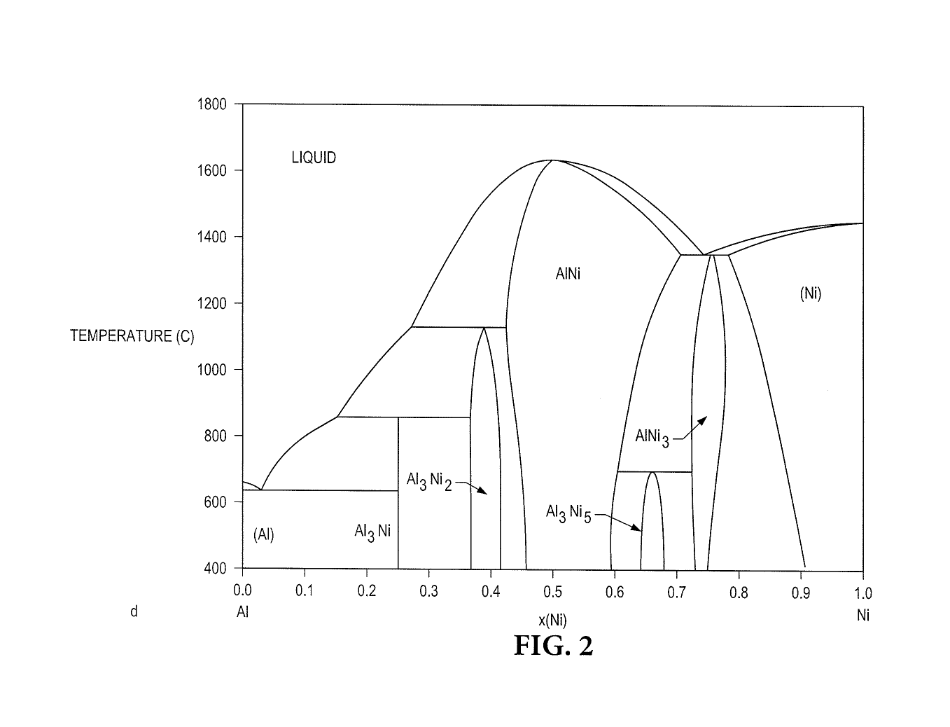

When activated by a small pulse of localized energy (e.g., temperature, electrical, optical, thermal, laser, mechanical pressure, combinations thereof, or other suitable source) the multilayer foil 110 reacts exothermically to precisely deliver localized heat up to temperatures of 1500° C. in fractions (thousandths) of a second. This reaction is self-sustaining due to the significantly negative value of enthalpy of mixing between the constituent materials (e.g., if X is aluminum and Y is nickel, the multilayer is composed of alternating layers of Al and Ni) to form a refractory intermetallic compound (e.g., Al—Ni), and can therefore propagate from one end of the bond to the other with no further input or stimulus. For example, the Al—Ni system may result in a refractory bond with a melting temperature up to 1638° C. (peak of the AlNi region; see FIG. 2) while being processed at significantly lower temperatures. Also, as shown in the binary phase diagram illustrated in FIG. 2 (composition is denoted as mole fraction, x), there are additional intermetallic phases that may form from an Al—Ni multilayer foil 110, depending on the composition of the foil. These additional phases include Al₃Ni₂ and AlNi₅ and may be formed if the composition of the multilayer foil 110 deviates far enough from 0.5 mole fraction Al and 0.5 mole fraction Ni. For example, a multilayer foil 110 composition of 0.75 mole fraction Ni and 0.25 mole fraction Al may form a bond comprising AlNi₃, whereas a multilayer foil 110 composition of 0.70 mole fraction Ni and 0.30 mole fraction Al may form a bond comprising a mixture of AlNi and AlNi₃.

The exothermic bonding foil 110 may be combined with additional braze alloy layers 130, as indicated in FIG. 1, to achieve bonding with either or both of the PCD table and cemented-carbide substrate. The heat that is required to melt the braze alloy layers 130 for bonding may be supplied entirely by the self-propagating exothermic reaction of the multilayer system. Additional layers may comprise In, Pb, Bi, Sn, Zr, Al, Au, Ag, Nb, Zn, Ti, Cu, any combination, mixture or alloy thereof, any active carbide former (i.e., a substance that forms a carbide layer with diamond), including, e.g., tungsten, molybdenum, titanium, chromium, manganese, yttrium, zirconium, niobium, hafnium, tantalum, vanadium, any combination, mixture or alloy thereof, and any alloy wherein the additional layers may provide compliance to further reduce residual stresses in the bond region or provide functionally graded properties. Any additional layer material may diffuse into or react with the multilayer foil 110 material to retain refractory bond properties.

Materials which may be used in the multilayer foil 110 include bilayers of alternating elements, such as Ni/Al, Al/Ti, Ti/Co, or Ti/a-Si or combinations thereof and the like, wherein the at least two constituents exhibit a significantly negative value of enthalpy of mixing. The metallic layers may be 1 to 100 nm thick and may be arranged in horizontal or vertical stacks of films and include a combination of reactive materials with at least one low-melting component. With increased bilayer thickness, the reaction velocity decreases and the reaction heat increases. Therefore, a specific balance between high reaction velocity and high reaction heat is necessary. The system alloy or an intermetallic compound (XY) is formed by intermixing elements (X and Y) due to atomic diffusion and/or chemical reaction. The overall foil thickness may on the order of 10 to 100 μm. A high applied mechanical pressure 140 to the PCD table 102 and substrate 104 may enhance the braze flow at the interface 120 and therefore improve the wetting of the diamond as well as reduce undesirable porosity in the braze joint. In such cases, a masking or non-wetting material 109 may be applied to the sides of the diamond table 102 and/or the substrate 104 to prevent overflowed material from adhering. Alternatively, void spaces can be formed or included in a controlled fashion to help mitigate stress concentrations. Such void spaces may be formed by including inert materials, such as ceramics, within the bond region.

Besides the configurations already presented, the exothermic material may have various other configurations that may further minimize heat input to the PCD table 102 or the resulting residual stress profile. For example, it may have a two-layer configuration immediately adjacent the PCD table 102 or substrate 104 wherein the other layer is a low-melting material (e.g., In, Pb, Bi, Sn, Al, Zn) that bonds to the other material (PCD table or substrate) due to sufficient heat input to that layer from the exothermic layer. Such a bond may also be facilitated by alloying the low-melting material with a reactive material (e.g., Ti). In either case, the localized heat may be buffered from either the PCD table or the substrate.

Furthermore, a thicker refractory intermediate layer Z, as indicated in FIG. 1, may be placed between the alternating layers of material X and Y. The intermediate layer Z which may serve as a thermal and strain buffer between the PCD table 102 and substrate 104. In such a configuration, the exothermic layers would produce bonds between the PCD table 102 and intermediate layer as well as between the intermediate layer and substrate 104. Such a configuration could be extended to further layers, if necessary, to further design a suitable functionally graded bond to minimize residual stresses at the interface between PCD table 102 and substrate 104.

Furthermore, it may be possible to utilize a combination of mixed powders wherein at least two comprise the materials required for exothermic bonding with at least one other (non-exothermic) material. The non-exothermic material may be a buffering material that may melt during bonding to form a more ductile bond or it may be refractory enough to remain solid through the process and provide a non-reacted network of material within the bond. Given that intermetallic materials are often brittle, the ductile materials that may be included in any of the afore-mentioned configurations may provide a suitably strong, tough, and/or strain-resistant bond and may include In, Pb, Bi, Sn, Zr, Al, Au, Ag, Nb, Zn, Ti, Cu, any combination, mixture or alloy thereof, and any active carbide former (i.e., a substance that forms a carbide layer with diamond), including, e.g., tungsten, molybdenum, titanium, chromium, manganese, yttrium, zirconium, niobium, hafnium, tantalum, vanadium, any combination, mixture or alloy thereof. Alternatively, at least one buffering material, such as a ceramic, may be utilized to produce controlled void spaces that may mitigate residual stresses.

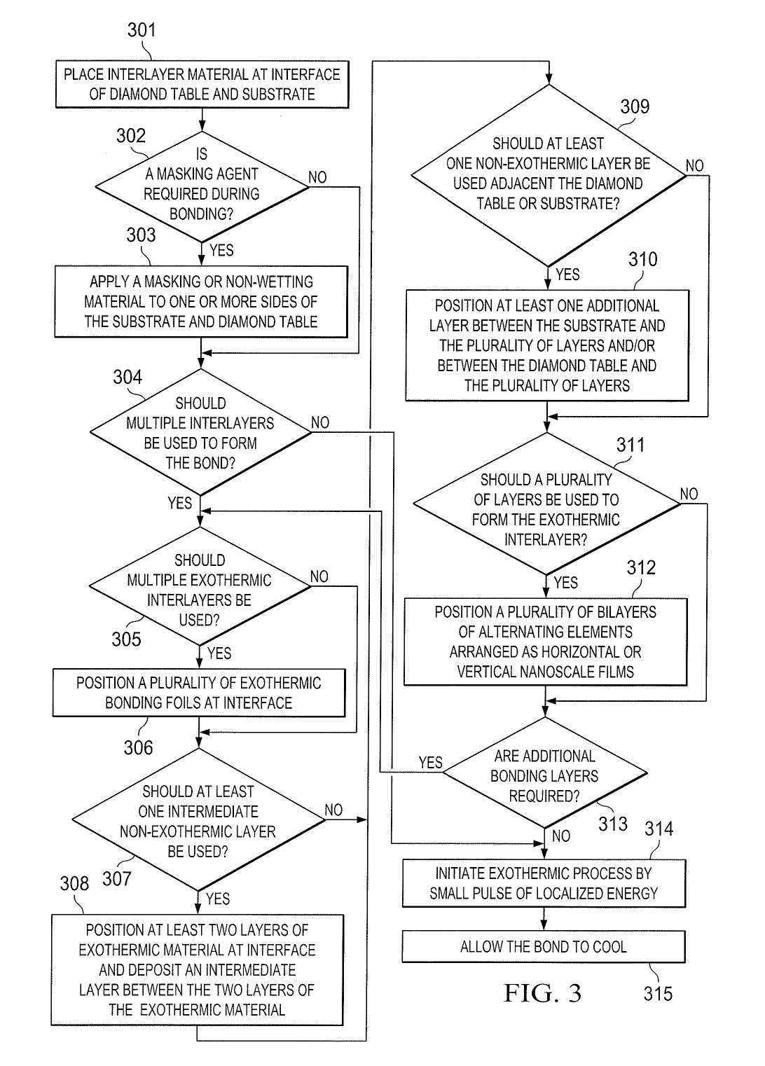

A method of forming a polycrystalline diamond cutter in connection with the present disclosure will now be described with reference to FIG. 3. As part of the method, an interlayer material is placed at an interface of the PCD table 102 and the substrate 104 (box 501). As those of ordinary skill will recognize, there are a number of different compositions that layer(s) may have and a number of different ways that it may be arranged relative to the substrate 104 and PCD table 102. See boxes 506, 508, 510, and 512. Part of the method, which is shown as a flow chart in FIG. 3, is to determine the structure and placement of those layers. While FIG. 3 shows the method as a linear decision tree, once the decisions are made about the structure and placement of those layers, the method proceeds to steps 503 (if performed), 514 and 515. Nonetheless, for ease of discussion, and to illustrate the many possible interlayer combinations, the method will be described linearly with reference to the flow chart shown in FIG. 3.

As part of the method, a determination is made as to whether a masking agent is required during bonding (box 502). If it is determined that masking agent is required, then a masking or non-wetting material is applied to one or more sides of the substrate and/or PCD table (box 503). If it is determined that a masking agent is not required, then the method proceeds.

As part of the determination of what the structure and placement of the interlayer material should be, one of the determinations that is made is whether multiple interlayers should be used to form the bond (box 504). If it is determined that multiple layers should be used to form the bond, then the method proceeds to the next step, which is to determine whether multiple exothermic interlayers should be used (box 505). If it is determined that multiple interlayers are not to be used to form the bond, then the method proceeds to box 514. If it is determined to use multiple exothermic layers (box 505), then a plurality of exothermic bonding foils may be placed at the interface (box 506). If it is determined that multiple exothermic layers are not be used, then the method proceeds to box 507.

Optionally, a determination may be made whether at least one intermediate non-exothermic layer should be used (box 507). If at least one non-exothermic intermediate layer is determined to be used, then the method proceeds to box 508. If it is determined not to use at least one intermediate non-exothermic layer, then the method proceeds to box 509. If the method proceeds to box 508, then at least two layers of the exothermic material are positioned at the interface and an intermediate layer is deposited between the two intermediate layers of the exothermic material. Optionally, a determination may be made as to whether at least one non-exothermic layer should be placed or used adjacent the diamond table or substrate (box 509). If it is determined that such a layer is to be used adjacent to the PCD table 102 or substrate 104, then the method proceeds to box 510, otherwise it may proceed to box 511.

If the method proceeds to box 510, then at least one additional layer may be positioned between the substrate 104 and the plurality of layers and/or between the PCD table 104 and the plurality of layers (110). Optionally, a determination may be made as to whether a plurality of layers should be used to form the exothermic interlayer (box 511). If it is determined to do so, the method proceeds to box 512, otherwise it may proceed to box 513. If the method proceeds to box 512, a plurality of bilayers of alternating elements may be arranged as horizontal or vertical nanoscale films. A determination may be made as to whether additional bonding layers are required (box 513). If they are required, the method proceeds back to box 505. Otherwise, it proceeds to box 514, at which point, the exothermic process is initiated by a small pulse of localized energy. After the exothermic process has been initiated and completed, the bond is then allowed to cool (box 515). The polycrystalline diamond cutter is then ready for any subsequent processing that may be required.

A method of forming a polycrystalline diamond cutter for use in a drill bit, comprising disposing a bonding agent at an interface between a polycrystalline diamond table and a substrate and initiating an exothermic reaction which causes the substrate to bond to the polycrystalline diamond table is provided. In any of the embodiments described in this this paragraph, initiating an exothermic reaction may be caused by a small pulse of localized energy. In any of the embodiments described in this paragraph, the small pulse of localized energy may be generated by an energy source which may be one of thermal energy, electrical energy, optical energy, laser energy, mechanical pressure, acoustic energy, or combinations thereof.

In any of the embodiments described in this or the preceding paragraph, disposing the bonding agent at the interface between the polycrystalline diamond table and the substrate may comprise disposing a plurality of layers of exothermic bonding foils at the interface between the polycrystalline diamond table and the substrate. In any of the embodiments described in this or the preceding paragraph, disposing the bonding agent at the interface between the polycrystalline diamond table and the substrate may further comprise disposing at least one additional layer between the substrate and the plurality of layers of exothermic bonding foils and/or at least one additional layer between polycrystalline diamond table and the plurality of layers of exothermic bonding. In any of the embodiments described in this or the preceding paragraph, the plurality of layers of exothermic bonding foils may be disposed by vapor depositing nanoscale layers of at least two alternating layers of different reactive materials. In any of the embodiments described in this or the preceding paragraph, the at least two alternating layers of different reactive materials may comprise alternating layers of Ni/Al, Al/Ti, Ni/Ti, Ti/Co, Ti/a-Si, or combinations thereof. In any of the embodiments described in this or the preceding paragraph, the at least two alternating layers of different reactive materials may exhibit a significantly negative value of enthalpy on mixing.

In any of the embodiments described in this or the preceding two paragraphs, disposing the bonding agent at the interface between the polycrystalline diamond table and the substrate may comprise disposing a plurality of bilayers of alternating elements arranged as horizontal or vertical nanoscale material films, the plurality of bilayers comprising a combination of reactive materials with at least one low-melting point component. In any of the embodiments described in this or the preceding paragraph, the method may further comprise applying a masking or non-wetting material to one or more sides of at least one of the substrate and polycrystalline diamond table. In any of the embodiments described in this or the preceding two paragraphs, disposing the bonding agent at the interface between the polycrystalline diamond table and the substrate may comprise depositing at least two layers of an exothermic material at the interface and depositing a refractory layer between the two layers of the exothermic material. In any of the embodiments described in this or the preceding two paragraphs, disposing at least two layers of an exothermic material at the interface comprises depositing two layers of an exothermic powder and depositing a refractory layer between the two layers of the exothermic material may comprise depositing a layer of a refractory powder between the two layers of the exothermic material. In any of the embodiments described in this or the preceding two paragraphs, the method may further comprise disposing heat sinks adjacent the polycrystalline diamond table and substrate.

The present disclosure includes PDC cutters formed in accordance with any of the methods described in the preceding three paragraphs. The resulting PCD cutters have improved thermo-mechanical integrity, improved abrasion resistance and a reduced likelihood of failure at the bond joint.

Although the present disclosure and its advantages have been described in detail, it should be understood that various changes, substitutions and alterations can be made herein without departing from the spirit and scope of the disclosure as defined by the following claims. It is intended that the present disclosure encompasses such changes and modifications as fall within the scope of the appended claims.

What is claimed is:

1. A method of forming a polycrystalline diamond cutter for use in a drill bit, comprising:
disposing a bonding agent at an interface between a polycrystalline diamond table and a substrate;
initiating an exothermic reaction which causes the substrate to bond to the polycrystalline diamond table.

2. The method according to claim 1, wherein initiating an exothermic reaction is caused by a small pulse of localized energy.

3. The polycrystalline diamond cutter according to claim 2, wherein the small pulse of localized energy is generated by an energy source which is selected from the group consisting of thermal energy, electrical energy, optical energy, laser energy, mechanical pressure, acoustic energy, and combinations thereof.

4. The method according to claim 1, wherein disposing the bonding agent at the interface between the polycrystalline diamond table and the substrate comprises disposing a plurality of layers of exothermic bonding foils at the interface between the polycrystalline diamond table and the substrate.

5. The method according to claim 4, wherein disposing the bonding agent at the interface between the polycrystalline diamond table and the substrate further comprises disposing at least one additional layer between the substrate and the plurality of layers of exothermic bonding foils and at least one additional layer between polycrystalline diamond table and the plurality of layers of exothermic bonding foils.

6. The method according to claim 4, wherein the plurality of layers of exothermic bonding foils are disposed by vapor depositing nanoscale layers of at least two alternating layers of different reactive materials.

7. The method according to claim 6, further comprising vapor depositing at least two alternating layers of different reactive materials, wherein the alternating layers are selected from the group consisting of Ni/Al, Al/Ti, Ni/Ti, Ti/Co, Ti/a-Si, and combinations thereof.

8. The method according to claim 7, further comprising vapor depositing at least two alternating layers of different reactive materials, wherein the at least two alternating layers of different reactive materials exhibit a significantly negative value of enthalpy on mixing.

9. The method according to claim 1, wherein disposing the bonding agent at the interface between the polycrystalline diamond table and the substrate comprises disposing a plurality of bilayers of alternating elements arranged as horizontal or vertical nanoscale material films, the plurality of bilayers comprising a combination of reactive materials with at least one low-melting point component.

10. The method according to claim 1, further comprising applying a masking or non-wetting material to one or more sides of at least one of the substrate and polycrystalline diamond table.

11. The method according to claim 1, wherein disposing the bonding agent at the interface between the polycrystalline diamond table and the substrate comprises vapor depositing at least two nanoscale layers of an exothermic material at the interface and depositing a refractory layer between the two layers of the exothermic material.

12. The method according to claim 11, wherein vapor depositing at least two nanoscale layers of an exothermic material at the interface comprises vapor depositing two nanoscale layers of an exothermic powder and depositing a refractory layer between the two nanoscale layers of the exothermic material comprises depositing a layer of a refractory powder between the nanoscale two layers of the exothermic material.

13. The method according to claim 1, further comprising disposing heat sinks adjacent the polycrystalline diamond table and substrate.

14. A polycrystalline diamond cutter formed by the method according to claim 1.

15. A polycrystalline diamond cutter formed by the method according to claim 4.

16. A polycrystalline diamond cutter formed by the method according to claim 5.

17. A polycrystalline diamond cutter formed by the method according to claim 8.

18. A polycrystalline diamond cutter formed by the method according to claim 9.

19. A polycrystalline diamond cutter formed by the method according to claim 11.

20. A polycrystalline diamond cutter formed by the method according to claim 12.
